(19) United States
(12) Patent Application Publication
(10) Pub. No.: US 2010/0229892 A1
(43) Pub. Date: Sep. 16, 2010

(54) Surface Cleaning Apparatus With Automatic Brush Speed Adjustment

(75) Inventors: Chad REESE, Auburn, AL (US); Brian R. McGee, Firestone, CO (US)

Correspondence Address: WOLF GREENFIELD & SACKS, P.C., 600 ATLANTIC AVENUE, BOSTON, MA, 02210-2206, US

(73) Assignee: Euro-Pro Operating LLC, West Newton, MA (US)

(21) Appl. No.: 12/390,278

(22) Filed: Feb. 20, 2009

Related U.S. Application Data
(60) Provisional application No. 61/030,459, filed on Feb. 21, 2008.

(51) Int. Cl. B08B 7/00; A47L 11/32

(52) U.S. Cl. 134/6; 15/41.1

(57) ABSTRACT

A surface-cleaning apparatus is disclosed. The apparatus includes one or more brushes rotatably driven by a motor in order to collect debris without suction being applied by the apparatus. The apparatus is capable of detecting a resistance or friction level of the surface to be cleaned, and can automatically adjust the rotational speed of the motor, and thereby the rotational speed(s) of the brush(es), based on changes in the surface. Additionally, the apparatus is capable of detecting jamming or locking of a brush and turning off the motor in response to detecting such jamming or locking.

### CROSS-REFERENCE TO RELATED APPLICATIONS

This application claims the benefit of U.S. provisional application No. 61/030,459, filed Feb. 21, 2008, the entire disclosure of which is incorporated herein by reference.

### FIELD OF THE INVENTION

This disclosure relates to a surface cleaning apparatus, such as for a floor or upholstery, incorporating a rotatable brush device and an electric motor for rotating the brush device.

### BACKGROUND OF THE INVENTION

Known suction-free surface cleaning apparatuses, such as for sweeping, include a brush device having an elongate brush, sometimes known as a brush bar, supported for rotation in a housing which is adapted to be propelled at least in a forward direction. Examples of such cleaning apparatuses are disclosed in U.S. Pat. No. 7,013,521 (Grey), the entire disclosure of which is incorporated herein by reference. In such apparatuses, the brush bar generally extends transversely to the housing and is adapted to contact an underlying surface or floor. The brush bar is arranged to be rotated by an electric motor, whereby rotation of the brush bar sweeps dirt, dust or debris particles into a storage bin in the apparatus. The housing can be provided with wheels which contact the surface being cleaned to facilitate propulsion of the housing.

The rotational speed of the brush/brush bar in a suction-free floor sweeper is critical to efficient collection of dirt, dust and debris. If the brush/brush bar is rotated at too high of a speed, the debris swept by the brush/brush bar will be swept at an excessive velocity such that much of the debris will be thrown away from the sweeper, and therefore will not be collected inside sweeper. If the speed of the brush/brush bar is too low, much of the debris swept by the brush bar will not be swept with sufficient velocity to be thrown inside sweeper. In vacuum cleaners that employ rotating brushes, the rotational speed of the brush is not nearly as critical, because the suction applied by the vacuum cleaner compensates for excessive or inadequate sweeping action from the brush.

The problem of employing appropriate brush speed in suction-free floor sweepers has previously been addressed by providing manually selectable speeds for the motor driving the brush. Thus, a user can manually adjust the speed of the motor, and thereby the rotational speed of the brush based on a change in the type of surface being cleaned. However, such a solution may require some trial and error on the part of a user to find the appropriate brush speed for a given surface, and requires that the user exert extra time and effort to achieve efficient operation of the floor sweeper.

It is therefore desirable to provide a suction-free floor sweeping apparatus that is capable of detecting the type of surface being cleaned and automatically selecting one of a plurality of motor speeds that will provide a brush speed suitable for efficient cleaning of the surface.

### SUMMARY OF THE INVENTION

It is an object of the invention to provide a surface cleaning apparatus which overcomes, or at least ameliorates, at least some of the shortcomings of known apparatuses.

According to one aspect of the invention, a method of controlling the sweeping action of a surface cleaning apparatus having a rotating brush, a motor driving the brush and load sensing circuitry for measuring a load on the motor, comprises: operating the motor to rotate the brush over a surface, generating load signals indicating values representative of levels of resistance to rotation of the brush presented by the surface using load sensing circuitry; and adjusting a rotational speed of the motor as needed, based on one or more of the load signals.

According to another aspect of the invention, a surface cleaning apparatus comprises: a body; a rotatable brush attached to the body and configured to engage a surface to be cleaned; a compartment disposed in the body for collecting debris swept by the brush; an electric motor configured to rotate the brush; a load sensing circuit in communication with the motor and configured to generate load signals indicating values representative of levels of resistance to rotation of the brush presented by the surface; and a control unit configured to sense the load signals and adjust a rotational speed of the electric motor as needed based on the load signals.

Additionally, the apparatus may comprise a rechargeable battery and a battery voltage sensing circuit configured to provide a signal to the control unit representative of a charge level of the battery. The control unit may be configured to power off the apparatus upon determination that the charge level is below a threshold charge level.

The control unit may also be configured to detect locking or jamming of the brush based on the load signal, and to turn off the motor upon detection of jamming or locking of the elongate rotatable brush.

The surface for cleaning by the apparatus of the present invention may be any surface which is to be swept and may be a floor, stairway, or upholstery, of premises or vehicles.

Additional features and benefits of the invention will be apparent to those skilled in the art upon reading the following detailed description.

### BRIEF DESCRIPTION OF THE DRAWINGS

The detailed description makes reference, by way of example, to the accompanying drawings in which:

FIG. 1 is a perspective view of an embodiment of surface cleaning apparatus according to the invention with part of a brush bar cover removed for clarity;

FIG. 2 is a perspective view of the apparatus of FIG. 4, with part of the housing thereof removed;

FIG. 3 is a schematic diagram of a control system for the apparatus;

FIG. 4 is a schematic representation of a control unit of the control system of FIG. 3; and

FIG. 5 is a schematic diagram of a motor control circuit of the control system.

### DETAILED DESCRIPTION OF THE INVENTION

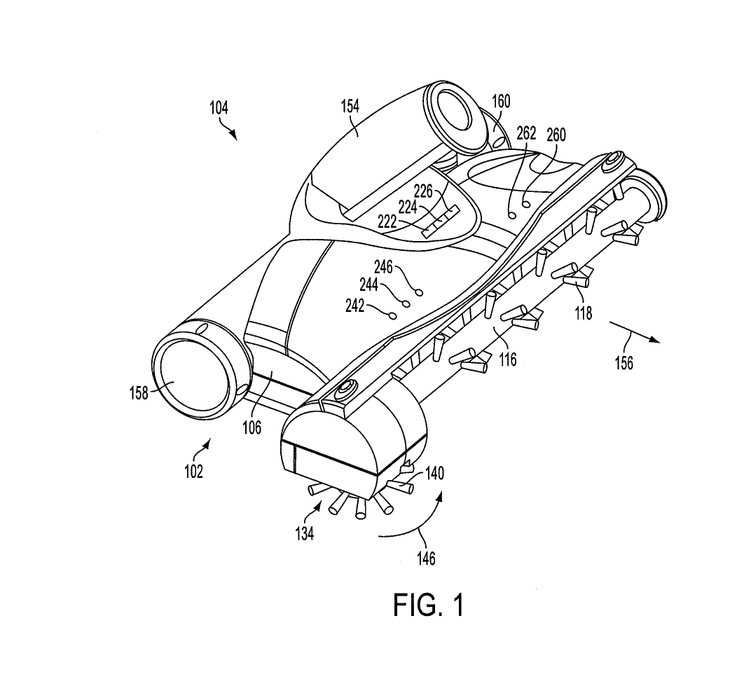

FIGS. 1-5 illustrate various features of a suction-free, electric surface cleaning apparatus (i.e., floor sweeper) 102 according to an embodiment of the invention. The floor sweeper 102 includes a brush device (brush bar 116 and, optionally, auxiliary brush 134) that is rotatably driven by a motor 110 to sweep dirt, dust and debris from a floor into the sweeper 102. The sweeper 102 is operated by a user simply powering the sweeper on and propelling (i.e., pushing and/or pulling) the sweeper 102 over a cleaning surface 104 (e.g., a floor, carpet or the like). The sweeper 102 continuously detects the resistance of the cleaning surface 104 to rotation of the brush device and automatically sets the rotational speed of the motor 110, and thus the rotational speeds of the brush bar 116 and auxiliary brush 134, to optimal speeds for the cleaning surface 104. Thus, when the sweeper 102 detects a change in resistance against rotation of the brush device, which is indicative of the brush device encountering a different surface, the sweeper 102 adjusts the rotational speed of the motor 110 to drive the brush bar 116 and auxiliary brush 134 at an optimum rotational speed for the different surface. The features and functions of the sweeper 102 are described in greater detail in the following paragraphs.

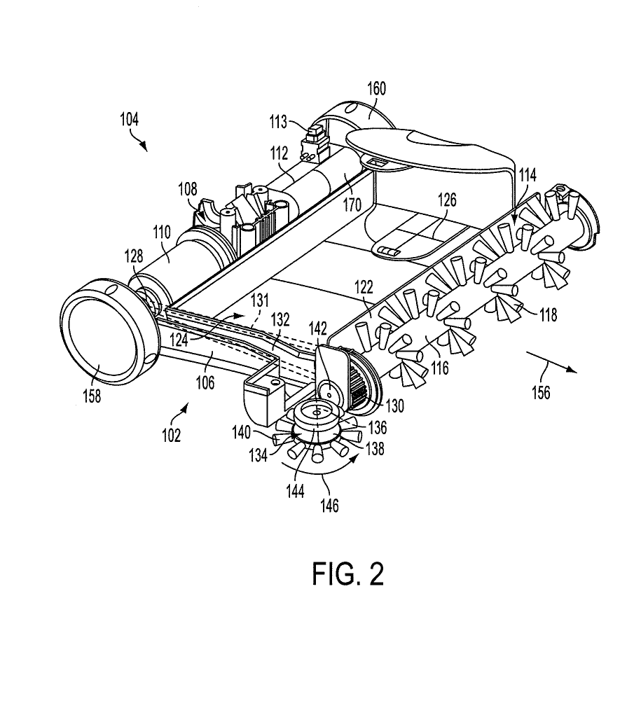

Referring to FIGS. 1 and 2, the sweeper 102 for cleaning comprises a housing 106 formed of molded plastics material, and effectively having three compartments. A rear compartment 108 houses the electric motor 110 and a rechargeable battery pack 112. The battery pack may be, for example, a seven-cell, 8.4 V_{dc} NiCd unit. The battery pack 112 may be connected to an AC power supply (not shown) for recharging the battery pack 112. The battery pack 112 may either be connected to the AC power supply whenever the apparatus is not in use or at suitable times when the battery pack has become depleted. A switch 113 is provided to permit a user to energize and de-energize the motor 110 as desired. As an alternative to a rechargeable battery pack, the apparatus may employ disposable batteries or be AC powered.

A forward compartment 114 houses the transversely-arranged elongate rotatable brush, or brush bar 116. The brush bar 116 includes bristles 118. The bottom of the forward compartment 114 is open at 120 to allow the bristles 118 of brush bar 116 to contact the cleaning surface 104 over which the apparatus is to be propelled. The rear of the forward compartment 114 is delimited by a rearwardly inclined wall 122. Rotation of the brush bar 116 causes dust, dirt, debris and the like to be propelled up the wall and to pass over the wall into an intermediate compartment 124. Thus, dust, dirt, debris and the like are swept and collected in the compartment 124 by rotation of the brush bar 116 without any suction being applied by the apparatus 102. The wall 122 extends upwardly to about the same height as the top of the brush bar 116 and may be angled rearwardly (i.e., away from the forward compartment 114) at an angle of about 18 degrees. The precise angle is not important, but the inclination facilitates passage of dust, dirt and debris up and over the wall 122 and at the same time facilitates retention of the dust, dirt and debris in the compartment 124. The front of the forward compartment is provided with a cover (not shown) which may be removable if desired. Debris accumulating in the intermediate compartment 124 can be removed by opening a cover 126.

The brush bar 116 is rotated by the motor 110 by way of toothed rollers 128, 130 attached to the motor and to the brush bar 116, respectively, and by way of a toothed belt 131, for example of elastomeric material, extending around the two rollers. The toothed belt 131 is enclosed within a tunnel 132 where it passes through or alongside the intermediate compartment 124 in order to prevent the ingress of debris into the rear compartment 108.

The auxiliary brush 134 is optionally provided extending outwardly from the housing 106 at the right hand side of the brush bar 116 as viewed from above and behind the apparatus 102. The auxiliary brush 134 is of substantially circular form and is supported for rotation about an axis 136, which may be vertical or inclined to vertical, such as at an angle of about 10 degrees to vertical. The auxiliary brush 134 has a body 138 provided with radial bristles 140 which are inclined at an acute angle to the axis of rotation 136 so as to effectively form a conical arrangement increasing in cross-section with increasing distance from the body 138.

The auxiliary brush 134 is rotatably driven from the rotating brush bar 116 by a gear wheel 142 at the end of the brush bar 116 which meshes with a further gear wheel 144 on the body 138 of the auxiliary brush 134. The auxiliary brush 134 is caused to be rotated in an anti-clockwise direction denoted by arrow 146, as viewed from above and behind the apparatus 102. The direction of rotation 146 of the auxiliary brush 134 ensures that debris is swept positively by the auxiliary brush 134 into a position ahead of the brush bar 116, ready to be picked up by the brush bar 116.

Because the apparatus relies solely upon rotation of the brush bar 116 and optional auxiliary brush 134 to collect debris, and does not apply suction, it is very important that the brush bar 116 and auxiliary brush 134 rotate at proper rotational speeds. Specifically, the rotational speed of the brush bar 116 must be high enough to lift debris away from the surface being cleaned and throw the debris into the compartment 124, but not so high that debris is thrown away from the apparatus 102. If the auxiliary brush 134 is provided, its rotational speed must be sufficient to sweep debris ahead of the brush bar 116 without throwing the debris too far away from the brush bar 116. Higher friction surfaces tend to retain debris more strongly, and will therefore require higher brush bar/auxiliary brush speeds to effectively lift debris away from the cleaning surface and into the compartment 124. Conversely, lower friction surfaces tend to retain debris more loosely, and therefore require lower brush bar/auxiliary brush speeds to effectively lift debris away from the surface and into the compartment 124.

The apparatus 102 is provided with a handle 154 by means of which it can be propelled at least in a forward direction 156. Wheels 158 and 160 are provided to enable or assist manual propulsion of the apparatus across the surface 104 to be swept, such as a floor, stairway or upholstery. The handle 154 could be longer, or be of a different shape or form, as required.

If desired, instead of or in addition to the auxiliary brush means 134 provided extending outwardly from the right hand side of the housing 106, a similar auxiliary brush (not shown) could likewise be provided extending outwardly from the left hand side of the housing 106 and driven from the opposite end of the brush bar 116. Such an additional or alternative auxiliary brush differs from the auxiliary brush 134 only in that it is caused to rotate in a clockwise, rather than anti-clockwise, direction as viewed from above and behind the apparatus 102.

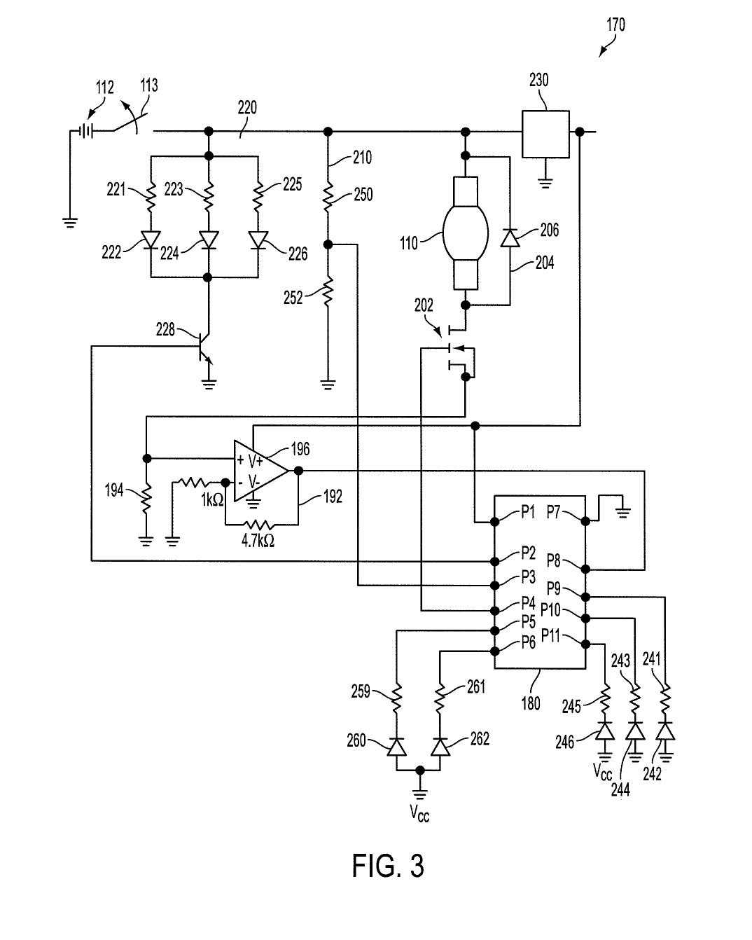

The apparatus 102 may include a control system 170 which controls multiple operations of the apparatus 102. The control system 170 may be located, for example, in the rear compartment 108. The control system 170, shown schematically in FIG. 3, is connected to the battery pack 112 via switch 113. The control system includes a control unit 180, a motor control circuit 190, a battery voltage sensing circuit 210 and a headlight circuit 220.

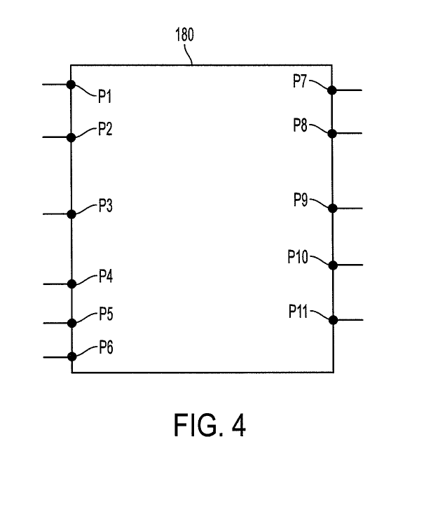

As shown in FIG. 4, the control unit 180 includes a plurality of inputs and outputs. Specifically, the control unit includes: a power input P1, a headlight digital output P2, a battery voltage input P3, a pulse width modulated (PWM) speed output P4, a low battery level output P5, a high battery level output P6, a ground connection P7, a motor current input P8 and motor speed indicating outputs P9-P11. The power supplied to the power input P1 of the control unit 180 is regulated by a voltage regulator 230. One example of a suitable control unit 180 is the Microchip PIC16F684 microcontroller having a maximum input voltage of 5.5 Vdc. However, other microcontrollers with a suitable number and type of inputs and outputs may be used.

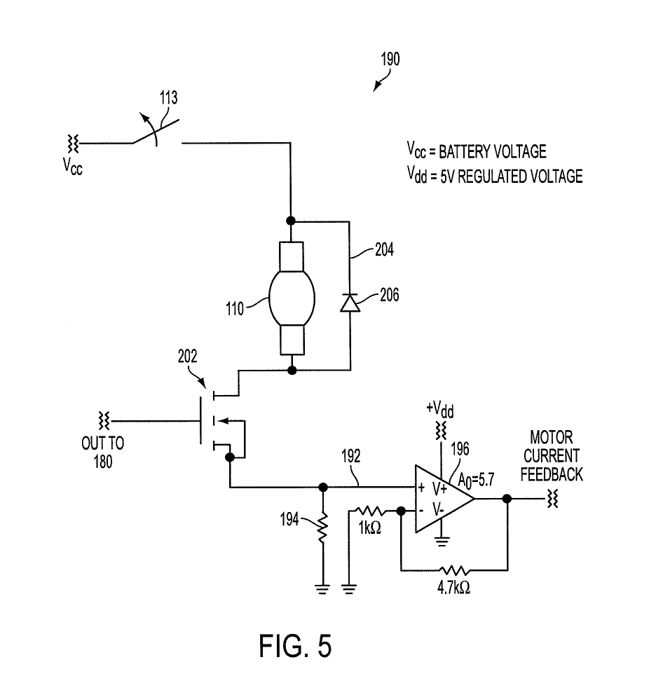

Referring to FIGS. 3 and 5, the motor control circuit 190 includes a motor current feedback circuit, or load sensing circuit 192 and a motor drive circuit 204, both of which are connected to a transistor 202. The motor current feedback circuit 192, motor drive circuit 204 and transistor 202 cooperate to control the speed of the electric motor 110 based on the surface type of the floor or surface being cleaned and to shut the motor off when the brush bar 116 becomes locked or jammed (e.g., due to obstruction by a foreign object). The transistor 202 is connected to the PWM speed output P4 of the control unit 180. According to one embodiment, the transistor 202 can be an N-channel enhancement mode MOSFET transistor. Such a transistor provides effective switching of the motor and is voltage controlled, thereby drawing no current from the control unit 180.

The motor current feedback circuit 192 may include a shunt resistor 194 placed in series with the electric motor 110 and a non-inverting op-amp 196 located between the shunt resistor 194 and the control unit 180. According to the embodiment shown in FIGS. 5 and 6, the op-amp 196 is powered by a regulated 5 Vdc (via voltage regulator 230) and provides an approximate gain of 5.7 between the shunt resistor 194 and the control unit 180. The output of the op-amp 196 is connected to the motor current feedback input P8 and thus inputs to the control unit 180 a feedback voltage that is representative of the actual current drawn by the motor. The regulation of the voltage supplied to the op-amp 196 avoids over-ranging the control unit 180.

The motor drive circuit 204 includes a diode 206 powered in parallel with the electric motor 110, thereby preventing current reversal through the motor. By way of its connection to the transistor 202, the speed of the motor 110 is controlled by a pulse width modulated signal output from the control unit 180 through the PWM speed output P4.

As a result of the arrangement of the control unit 180 and the motor control circuit 180, the control unit 180 is able to sense the amount of current drawn by the motor 110 as a result of the surface resistance of the floor or surface being cleaned and set the rotational speed of the motor 110, and thereby the rotational speed of the brush bar 116, to account for the surface resistance. Thus, it is ensured that the brush bar 116 rotates at a proper speed for effectively collecting debris. Specifically, the control unit 180 reads the voltage drop across the shunt resistor 194 and generates a PWM speed output signal corresponding to a programmed voltage range encompassing the measured voltage drop. For example, relatively rough surfaces such as carpet surfaces will present more resistance to rotation of the brush bar 116 than smooth surfaces such as tile, linoleum or hardwood surfaces, which results in a higher motor current and therefore a higher voltage drop across the shunt resistor 194. Likewise, certain types of carpet surfaces may present more or less resistance to rotation of the brush bar 116 than others and, accordingly, will cause a higher or lower voltage drop across the shunt resistor 194. Upon sensing predefined changes the voltage drop across the shunt resistor 194, the control unit 180 is able to modify the PWM speed output signal P4 to increase or decrease the rotational speed of the motor 110, and thereby proportionally increase or decrease the rotational speed of the brush bar 116, as needed to ensure effective cleaning of a given surface. In the disclosed cleaning apparatus 102, it is critical that the rotational speed of the brush bar 116 be sufficiently high to enable effective collection of dirt, dust and debris. Generally, the control unit 180 will cause the motor 110 and brush bar 116 to operate at higher speeds on more resistive surfaces.

Additionally, the control unit 180 may be programmed to shut the motor 110 off when the feedback voltage from the motor current feedback circuit 192 exceeds a threshold that indicates locking or jamming of the brush bar 116. This shut-off feature protects the motor 110 and other components of the cleaning apparatus from damage.

In reading the voltage drop across the shunt resistor 194, the control unit 180 can look at the most significant bits of the analog-to-digital conversion of the feedback voltage signal. Alternatively, the control unit 180 can be programmed to look at the least significant bits of the feedback voltage signal, and the op-amp 196 and related components could be eliminated. Furthermore, as an alternative to reading the voltage drop across the shunt resistor 194, the shunt resistor 194 may be eliminated, and a voltage difference across a section of printed circuit board trace in the motor drive circuit 204 could be read.

The control unit 180 may include or be in communication with to a memory device (not shown) which includes an electronic database or look-up table containing motor speed values associated with prescribed voltage drop ranges or current draw ranges. Thus, the control unit 180 may access the look-up table to select a prescribed motor rotational speed value associated with a voltage drop range or current draw range determined based on the output of the feedback circuit.

In the embodiment of FIGS. 3 and 5, the control unit 180 is programmed to operate the motor 110 at one of three speeds (e.g., low, medium and high). According to one embodiment, it is advantageous to provide a low speed of 1900-2500 rpm (typically suited for hard floors), a medium speed of 2500-3200 rpm (typically suitable for low pile carpets), and a high speed of 3300-3800 rpm (typically suitable for thick carpets. Any one of the motor speeds may be selected a as the default speed. As shown in FIG. 3, three speed indicating LEDs 242, 244, 246 may be connected to the respective motor speed indicating outputs P9, P10, P11 and may be arranged to illuminate to indicate whether the motor 110 is off or operating at low, medium or high speed. Resistors 241, 243, 245 may be respectively placed in series with the LEDs 242, 244, 246 to limit the amount of current to the LEDs 242, 244, 246. The LEDs 242, 244, 246 may be installed in the apparatus 102 so as to be visible through the housing 106 (FIG. 1) or another part of the apparatus 102. According to one example, the following illumination scheme shown in Table 1 may be employed.

TABLE 1
Speed/LED Indication

| Motor Speed | Number of LEDs Illuminated |
|---|---|
| Low | 1 |
| Medium | 2 |
| High | 3 |
| Off/Lock-bar | 0 |

A single tri-color LED having three pin connections connected to the outputs P9, P10, P11 may be used in place of the three LEDs 242, 244, 246, wherein the color displayed by the LED (e.g., red, green or yellow) is a result of number of connections that are turned on.

Although the illustrative embodiment provided herein includes three motor speeds, it is noted that a greater number of motor speeds may be provided for more precise control and performance, or fewer speeds (two) may be provided for greater simplicity.

When the battery pack 112 is of the NiCd variety, allowing the battery pack 112 to discharge too low can cause cell reversal, which can damage the battery pack 112 and shorten its life. With this issue in mind, the control system 170 may also be provided with the capability of shutting the apparatus 102 off when the voltage of the battery pack 112 falls below a programmed threshold voltage value. To accomplish this feature, the battery voltage sensing circuit 210 may include two resistors 250, 252 arranged in series with respect to each other to form a voltage divider, and a node 254 at the middle of the voltage divider may be connected to the battery voltage input P3. In the embodiment shown, the resistors 250, 252 are each 1 MΩ resistors, and allow the control unit 180 to read one half of the battery voltage in order to avoid over-ranging of the input P3. The control unit 180 reads the voltage level registered from the battery voltage sensing circuit 210 and decides whether to run or shut off the motor 110.

As shown in FIG. 3, a low battery level LED 260 may be connected to the low battery level output P5 of the control unit 180, and a high battery level LED 262 may be connected to the high battery level output P6 of the control unit 180. Resistors 259, 261 can be placed in series with the LEDs 260, 262, respectively, to limit the current drawn by the LEDs 260, 262. To facilitate reading of the battery level indication, the LED 260 and the LED 262 may illuminate in different colors, such as red and green, respectively. The LEDs 260, 262 may be visible through the housing 106 (FIG. 1) or another part of the apparatus 102. Table 2 below indicates one possible illumination scheme for indicating battery status.

TABLE 2
Battery Status Output

| Battery Charge Status | Output |
|---|---|
| V_{battery} > 7.4 Vdc | Green |
| 6.3 Vdc < V_{battery} < 7.4 Vdc | Green and Red |
| V_{battery} < 6.3 Vdc | Red (system shutdown) |

In addition to the foregoing features, the cleaning apparatus 102 may include a headlight circuit 220 for controlling the operation of headlights 222, 224, 226. The circuit 220 may include an NPN bipolar transistor 228 as a DC switch controlled by the control unit 180 to turn the headlights 222, 224, 226 on and off. Current to the headlights 222, 224, 226 may be limited by resistors 221, 223, 225 placed in series with the headlights 222, 224, 226. The control unit 180 may be programmed to turn the headlights 222, 224, 226 on when the motor is on and off when the motor is off. Additionally, the control unit 180 may be programmed to flash the headlights 222, 224, 226 on and off when the brush bar 116 is locked or jammed.

In controlling the motor speed and motor shutdown functions, the control unit 180 may take multiple readings of the voltage drop across the motor or current drawn by the motor within a processing or “clock” cycle of the control unit 180. The control unit 180 may use a single reading, average the multiple readings, or otherwise use the multiple readings within a clock cycle to determine an effective value of the voltage drop or current draw, which is then used to select a desired rotational speed of the motor or shut the motor off in the case of a brush bar lock-up or jam by referencing the electronic database. Similarly, the control unit 180 may take multiple readings of the battery voltage within a clock cycle and determine an effective value for the battery voltage based on a single reading, an average of the multiple readings, or another calculation based on the multiple readings within the clock cycle. According to one embodiment, the control unit 180 may take sixteen or more readings of the voltage drop across the motor or current drawn by the motor, as well as the battery voltage, within a single clock cycle of the control unit 180.

The foregoing disclosure provides illustrative embodiments of the invention and is not intended to be limiting. It should be understood that modifications of the disclosed embodiments are possible within the spirit and scope of the invention, and the invention should be construed to encompass such modifications.

We claim:

1. A method for controlling the sweeping action of a surface cleaning apparatus having a rotating brush, a motor driving the brush and load sensing circuitry for measuring a load on the motor, the method comprising:
operating the motor to rotate the brush over a surface;
generating load signals indicating values representative of levels of resistance to rotation of the brush presented by the surface using the load sensing circuitry;
adjusting a rotational speed of the motor as needed, based on one or more of the load signals.

2. The method of claim 1, wherein the load signals indicate voltage drops across the motor or current drawn by the motor.

3. The method of claim 1, wherein adjusting the rotational speed of the motor comprises:
determining an effective load value based on one or more of the values indicated by the load signals;
accessing an electronically stored database comprising a plurality of load value ranges and associated prescribed motor rotational speed values; and
selecting one of the prescribed motor rotational speed values associated with a load value range within which the effective load value falls.

4. The method of claim 3, wherein the effective load value is an average of multiple load values.

5. The method of claim 3, comprising shutting off the motor when the effective load value exceeds a specified threshold value.

6. The method of claim 1, wherein the values indicated by the load signals indicate voltage drops across the motor or current drawn by the motor.

7. The method of claim 1, comprising using an electronic control unit to sense the load signals and adjust the rotational speed of the motor.

8. The method of claim 1, wherein an electronic control unit automatically senses the load signals and adjusts the rotational speed of the motor.

9. The method of claim 1, wherein the surface cleaning apparatus is a suction-free floor sweeper.

10. The method of claim 1, wherein the motor is capable of operating at one of at least three prescribed rotational speeds.

11. The method of claim 1, wherein the surface cleaning apparatus comprises a debris collection compartment positioned behind the brush for collecting debris swept by the brush, wherein the debris collection compartment is separated from the brush by a rearwardly inclined wall, and wherein the rotation of the brush propels the debris up the wall and into the debris collection compartment without the application of suction by the apparatus.

12. A surface cleaning apparatus comprising:
a body;
a rotatable brush attached to the body and configured to engage a surface to be cleaned;
a compartment disposed in the body for collecting debris swept by the brush;
an electric motor configured to rotate the brush;
a load sensing circuit in communication with the motor and configured to generate load signals indicating values representative of levels of resistance to rotation of the brush presented by the surface; and
a control unit configured to sense the load signals and adjust a rotational speed of the electric motor as needed based on the load signals.

13. The apparatus of claim 12, wherein the load signals indicate voltage drops across the motor or current drawn by the motor.

14. The apparatus of claim 12, wherein that control unit is configured to adjust the rotational speed of the motor by:
determining an effective load value based on one or more of the values indicated by the load signals;
accessing an electronically stored database comprising a plurality of load value ranges, and associated prescribed motor rotational speed values; and
selecting one of the prescribed motor rotational speed values associated with a load value range within which the effective load value falls.

15. The apparatus of claim 14, wherein the effective load value is an average of multiple load values.

16. The apparatus of claim 14, wherein the control unit is configured to shut off the motor when the effective load value exceeds a specified threshold value.

17. The apparatus of claim 12, wherein the values indicated by the load signals indicate voltage drops across the motor or current drawn by the motor.

18. The apparatus of claim 12, wherein the surface cleaning apparatus is a suction-free floor sweeper.

19. The apparatus of claim 12, wherein the motor is capable of operating at one of at least three prescribed rotational speeds.

20. The apparatus of claim 12, wherein:
the compartment is positioned behind the brush and is separated from the brush by a rearwardly inclined wall; and
the rotation of the brush propels the debris up the wall and into the compartment without the application of suction by the apparatus.
